(19) United States
(12) Patent Application Publication
(10) Pub. No.: US 2008/0260544 A1
(43) Pub. Date: Oct. 23, 2008

(54) Clamping Sleeve for an Ejector, and Mounting Procedure

(75) Inventor: Peter Tell, Akersberga (SE)

Correspondence Address: YOUNG & THOMPSON, 209 Madison Street, Suite 500, ALEXANDRIA, VA, 22314, US

(73) Assignee: XEREX AB

(21) Appl. No.: 12/091,777

(22) PCT Filed: Oct. 17, 2006
(86) PCT No.: PCT/SE2006/001172

§ 371 Date: Apr. 28, 2008

(30) Foreign Application Priority Data
Oct. 27, 2005 (SE) 0502371-8

(51) Int. Cl. F04F 5/22; F04F 5/46; B23P 15/00

(52) U.S. Cl. 417/163; 417/198; 29/888.02

(57) ABSTRACT

An ejector which is operative for generating a sub-pressure, has a rotationally symmetric ejector body arranged to be mounted in the mouth of a seat having a circular internal section, whereby in a mounted position an inlet end of the ejector body is inserted in the seat and an outlet end thereof projects outside the mouth of the seat. The ejector body has on its exterior a region of defined axial length with a radius that is growing towards the inlet end, the region being situated between inlet and outlet ends, as well as a shoulder having an abutment surface facing the region, the shoulder being arranged on the ejector body near the outlet end thereof. The ejector is arranged for supporting a cylindrical clamping sleeve for a limited axial displacement about the ejector body, between the shoulder and the region.

### TECHNICAL FIELD

The invention refers to an ejector effective for generating sub-pressure, the ejector having a rotationally symmetric ejector body exterior arranged to be detachably mounted by means of a clamping sleeve in the mouth of a seat having circular section. The invention analogously relates to a procedure for mounting a high pressure operated vacuum-pump having a rotationally symmetric ejector body.

### BACKGROUND AND PRIOR ART

Ejector type pumps are driven by pressurized air for generating sub-pressure and are well known. These ejectors are operated through high pressure air which passes at high speed through a number of nozzles arranged in series, and having air slots formed between the nozzles. In result of the velocity of the air flow, a fall in pressure is generated at the air slot between two nozzles arranged in succession, effecting an evacuation of air from an adjacent space that communicates with the nozzles and the inter-positioned slots via openings arranged in the ejector body. Such ejectors of various designs are used in a large number of applications within different industrial sectors, wherein vacuum is used in the process. The expression “vacuum” as used herein shall be understood as a condition under which the pressure is lower than the atmosphere, but is not necessarily equal to a completely pressure-free state.

Vacuum-pumps/ejectors suitable for integration in tools that are operated through sub-pressure, or other structures associated with such tools, have been developed in order to meet a demand for shorter evacuation paths and faster processes. One ejector which is designed specifically to provide a far-reaching freedom of choice for installation is disclosed in WO 99/49216. This ejector has an ejector body with a circular or rotationally symmetric exterior, and nozzles coaxially arranged inside the ejector body.

This rotationally symmetric ejector is mountable in the mouth of a seat with a circular section, such that an inlet end of the ejector body is inserted into the seat while an outlet end of the same projects outside the mouth of the seat, in a mounted position. The subject seat may be shaped as a tube, or as a cylindrical bore formed in any structural member. An inlet for feeding pressurized air to the inlet end of the ejector leads to the seat, as well as an inlet for air to be evacuated from a space or from a tool communicating with the evacuated space.

This type of ejector is typically arrested in the seat through a threaded engagement with the seat wall, either directly by means of threads arranged on the exterior of the ejector body, or indirectly by means of a thread formed on the exterior of an adapter, such as a silencer adapter which is connectable in the outlet end of the ejector body. In each case, threads need to be formed on the interior of the seat as well as on the exterior of the ejector body.

### SUMMARY OF THE INVENTION

The present invention aims to provide an ejector of the type mentioned above, by which the time needed for mounting of the same is reduced through an ejector design which removes the need for threads to be cut internally in the seat.

This object is met through the ejector and procedure as defined in the claims.

Briefly, according to the present invention, there is provided an ejector operative for generating sub-pressure and having a rotationally symmetric ejector body exterior adapted to be mounted in the mouth of a seat which is formed internally with a cylindrical section, such that in the mounted position an inlet end of the ejector body is inserted in the seat and an outlet end thereof projects outside the mouth of the seat, with a sleeve which is supported about the ejector body for limited axial displacement thereon, and operative for arresting the ejector in the seat together with the sleeve, said sleeve comprising a cylindrical sleeve wall which is urged by the ejector body to be expanded in radial direction as the sleeve is axially displaced on the ejector body, the sleeve having an outer radius which is dimensioned for clamping the sleeve between the ejector body and the seat in result of its radial expansion.

Preferably, the ejector on its exterior comprises on one hand a region of growing radius and of defined axial length diverging towards the inlet end, situated between the inlet and outlet ends, and on the other hand a shoulder facing towards the inlet end and arranged on the ejector body, near the outlet end thereof.

Preferably, the region of growing radius diverging towards the inlet end of the ejector body is conically tapering towards the outlet end. That end of the conical region which faces the inlet end of the ejector body may be adjoining a groove that is formed to receive a ring-shaped sealing member mountable about the ejector body.

The shoulder may be formed on the ejector body, or alternatively formed on an adapter, such as a silencer adapter, connectable to the ejector body.

Preferably, a spring member abutting the shoulder is supported on the ejector body exterior, said spring member operating between the shoulder and the sleeve supported about the ejector body, the spring member being effective for biasing the sleeve towards the inlet end of the ejector body. To this purpose, the shoulder may be formed with a ring-shaped groove for insertion of a coiled spring member in the shoulder.

Through at least the measures first mentioned, the ejector is arranged for supporting, about the ejector body, a cylindrical sleeve which is for a limited length axially displaceable between the shoulder and the region of growing radius.

The ejector according to the invention is thus mountable in the seat's mouth in cooperation with a clamping sleeve comprising a cylindrical sleeve wall, an inner radius of which is dimensioned for expanding the sleeve in radial direction as the sleeve is displaced with respect to the ejector body into said region of growing radius, wherein an outer radius of the sleeve is dimensioned for clamping the sleeve between the ejector body and the wall of the seat in effect of the resulting radial expansion of the sleeve. This way, the ejector body is arrested in the seat through a wedging action.

A straight cylindrical outer surface is advantageously formed on the ejector body and situated between the shoulder and the region of growing radius towards the inlet end, said cylinder surface preferably adjoining the shoulder and having a radius which is adapted for guidance of the sleeve in axial displacement about the ejector body.

The sleeve supported on the ejector body preferably comprises a cylindrical wall that is divided into sections, separated through axial slots. The sections are mutually connected in that end of the sleeve which faces said shoulder. On the exterior, the sleeve wall sections may have means that engages the wall of the seat by friction.

Further, the sleeve advantageously comprises a ring-shaped collar in that end of the sleeve which faces said shoulder, the collar reaching radially outside the outlet end of the ejector body. From the periphery of the collar, a cylindrical portion which is terminated as a grip for fingers reaches past the ejector body in the extension of the outlet end.

The inner sides of the sleeve's sections are formed with wedge-shaped heels, respectively, arranged in that end region of the sleeve which faces the inlet end of the ejector. The wedged heels have a sloping slide surface, the inclination of which is adapted to the inclination of the tapering region on the ejector body so as to clamp the sleeve between the ejector body and the seat wall through a wedging action, as the sleeve is displaced into said region of growing radius.

Mounting of an ejector operated by high pressure air and arranged as described is accomplished through insertion, into the seat, of the ejector body together with the cylindrical sleeve supported there about, and radially expanding the sleeve for clamping between the seat and the ejector body in result of an axial displacement of the sleeve with respect to the ejector body.

In a preferred embodiment, the method comprises the steps of:
forming a cylindrical seat with a radius adapted for insertion of a rotationally symmetric ejector body together with an expandable sleeve supported about the ejector body;
threading a coiled spring over the ejector body, from an inlet end towards an outlet end thereof, until the coiled spring abuts a shoulder;
threading, in said direction, the sleeve over the ejector body until the sleeve engages the coiled spring;
applying one or several ring-shaped sealing means about the ejector body;
displacing the sleeve towards the shoulder against the force of the coiled spring;
insertion of the ejector body and sleeve under bias from the spring such that the sleeve is positioned inside the mouth of the seat;
pulling the ejector body outwards, in effect of the operation of the coiled spring acting between the ejector body and the sleeve, resulting in a radial expansion of the sleeve by which the ejector body is arrested in the seat through a wedging action.

### SHORT DESCRIPTION OF THE DRAWINGS

The invention will be more closely described below with reference to an embodiment, diagrammatically illustrated in the drawings, wherein

FIG. 1 shows in an elevation view an ejector according to the invention;

FIGS. 2a and 2b show an end view and a section, respectively, of a sleeve cooperating with the ejector of FIG. 1, and

FIG. 3 shows, on a larger scale, a sectional view through the ejector in a mounted position thereof.

### DETAILED DESCRIPTION OF THE EMBODIMENT

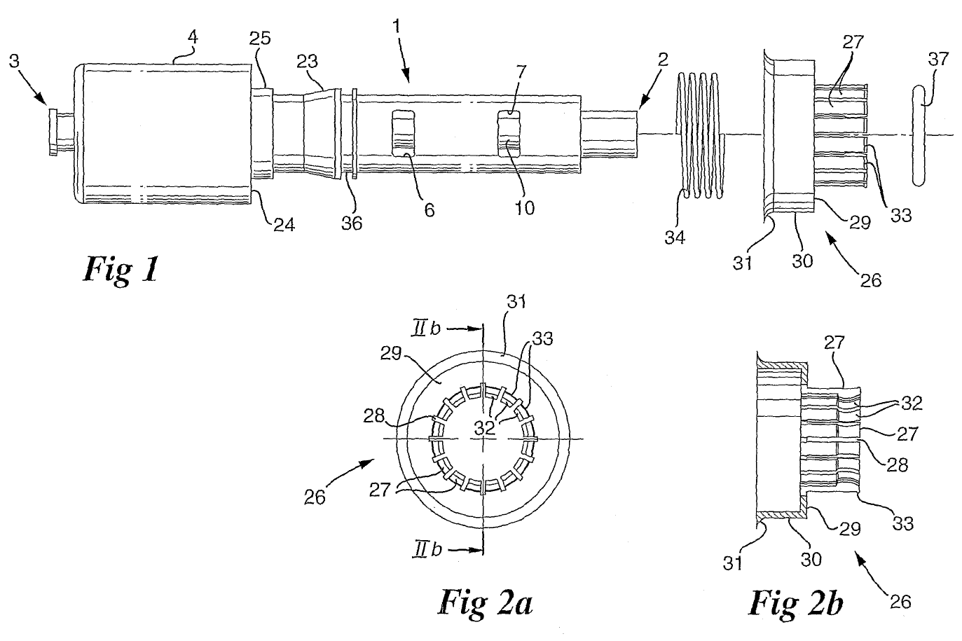

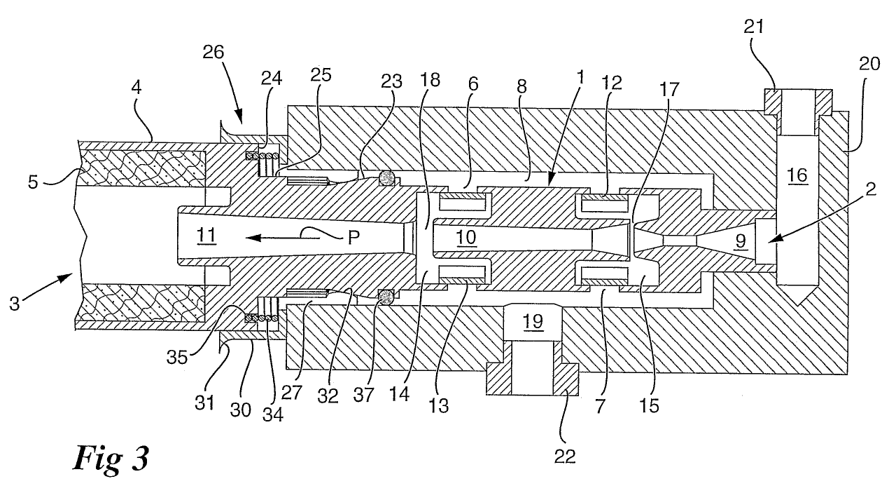

An ejector according to FIGS. 1-3, operative for generating a sub-pressure, comprises an ejector body 1 which has, at least over a substantial length thereof, a circular or rotationally symmetric exterior. The ejector body 1 reaches from an inlet end 2 to an outlet end 3, the latter carrying in this embodiment a housing 4 intended for a silencer insert 5 (visible also in FIG. 3). Openings 6,7 through the wall of the ejector body provide communication between a surrounding space 8, from where air is to be evacuated, and two or more nozzles 9,10,11 arranged on a common centre axis in a flow direction P through the ejector. One way valve members 12,13 (omitted in FIG. 1) open for flow of evacuated air from the space 8 into inner cavities 14,15 formed in the ejector body, as long as the pressure prevailing in said cavities is below the pressure prevailing in the space 8. In a manner known per se, the sub-pressure in cavities 14,15 is generated through the in-feed of high pressure air via an inlet 16. Upon passage through the nozzles in the flow direction P, the high pressure air forms a high speed jet that creates a fall in pressure in slots 17,18 as the jet passes between the nozzles arranged in series. The sub-pressure thus achieved in the space 8 may be used for operating a tool connected via an inlet 19.

In this embodiment the ejector body 1 is mountable in a structural member 20, shown diagrammatically, wherein the space 8 is formed as a seat having a circular section and mouthing through an end wall of the structural member. The inlets 16,19 to the seat comprises connections 21 and 22, diagrammatically illustrated, for pressurized air and for a tool operated through sub-pressure, respectively.

The ejector body 1 of the present invention comprises on its exterior a region 23 of defined axial length, formed with a growing radius towards the inlet end and situated between the inlet and outlet ends. Preferably, the region 23 is conically tapering towards the outlet end. Near the outlet end of the ejector body there is further provided a shoulder 24 at the ejector body 1, said shoulder comprising an abutment surface extending in radial direction and facing towards the inlet end. The shoulder 24 may be formed on the ejector body 1 or on an adapter connectable to the ejector body, such as a silencer adapter (where appropriate functioning in correspondence with the operation of the housing 4 and silencer insert 5 of the illustrated embodiment).

A region 25 having a straight cylindrical surface is formed between the shoulder 24 and said region 23. The region 25 has a radius adapted to operate as a guide surface 25 for a sleeve 26 which is supportable about the ejector body so as to a limited length be axially displaceable between the shoulder 24 and said region 23.

The sleeve 26 has a cylindrical wall which is divided into sections 27, separated through axial slots 28. The wall sections are mutually connected through a ring-shaped collar 29 having a radial dimension, and from a periphery of which a cylindrical portion 30 reaches in the axial direction to be terminated as a grip 31 for the fingers. The sleeve 26 has an inner radius adapted for threading the sleeve onto the ejector body 1, from the inlet end towards the outlet end thereof, until the collar 29 of the sleeve abuts the shoulder 24. The sleeve extends, in its fully applied position, concentric with the ejector body in a region near the outlet end thereof. For insertion purposes, an inner radius of the sleeve is closely related to and slightly larger than a radius of the guide surface 25, the radius of which is equal to or larger than the widest radius of the tapering region 23 on the ejector body.

The wall sections 27 are provided a flexibility in the radial direction, by which the cylindrical sleeve wall is radially expandable. The flexibility is provided through a corresponding choice of material for the sleeve 26, such as metal or synthetic material, e.g. Each wall section 27 is formed on an inner side with a slide surface 32, sloping with respect to the sleeve and arranged on a radially inwards protruding heel in an end region of each wall section. In the sleeve's mounted position, these heels are pointing towards the inlet end of the ejector body. The slide surfaces 32, if appropriate at least partially planar or slightly arcuate in shape, have an angle of inclination which is determined to provide expansion in the radial direction of the cylinder wall of the sleeve, as the sleeve is displaced with respect to the ejector body towards the inlet end thereof, into the tapering region of the ejector body, this way clamping the sleeve between the ejector body and the seat wall through a wedging action upon mounting. The axial length of the wall sections 27 is determined to allow the sleeve to be supported on the ejector body in a position, preferably a biased position as will be further explained below, wherein the sleeve is axially displaced towards the shoulder 24 without the cylindrical wall of the sleeve being expanded.

In order to provide frictional engagement between the seat wall and the sleeve when expanded on the ejector body, the wall sections 27 may on an outer side be formed with friction producing means 33. Said means may be arranged in the form of ridges, teeth or edges, running transverse to the wall sections 27 and preferably near the outer ends thereof. Specifically, here is suggested that one or several arcuately shaped edges made of metal or hard metal are moulded into each wall section 27 of a sleeve made of plastic.

A spring-powered bias of the sleeve 26 towards the inlet end of the ejector body and towards the region 23 thereof is provided through a spring member 34 abutting the shoulder on the exterior of the ejector body, said spring member acting between the shoulder 24 and the sleeve 26 supported on the ejector body. Preferably, the spring member 34 is a coiled spring inserted in a ring-shaped groove 35 formed in the abutment surface of the shoulder.

In the illustrated embodiment, the region 23 adjoins a groove 36 intended for a ring-shaped sealing means 37. Although not illustrated in the diagrammatic drawings, additional sealing means may be provided in appropriate positions on the ejector body.

A high pressure operated vacuum-pump according to the invention may easily be integrated in a tool, or in a structural member associated with a tool, if the same is provided with a cylindrical seat having a radius that is adapted for insertion of the ejector body together with the clamping sleeve supported thereabout. The coiled spring is applied about the ejector body from the inlet end towards the outlet end before insertion, until the coiled spring abuts the shoulder. Then, the sleeve is slipped onto the ejector body, in the same direction, until the sleeve abuts the coiled spring. In this position, one or several sealing means may be applied onto the ejector body without hindering the sleeve from being threaded over the ejector body. To effect insertion of the ejector body into the seat, the sleeve is displaced axially towards the shoulder against the force of the spring, followed by insertion of ejector body while the sleeve is under bias until the sleeve is positioned internally in the mouth of the seat. The ejector body is then further inserted until the collar of the sleeve abuts the structural wall encircling the seat mouth. Finally, the ejector body is allowed to spring outwards in the flow direction as a result of the force of the coiled spring acting between the ejector body and the sleeve. In effect of the relative displacement between ejector body and sleeve, the sleeve is expanded in radial direction through the tapering region formed on the ejector body, this way clamping the sleeve between the ejector body and the wall of the seat, if appropriate with support from a frictional engagement provided by frictional means arranged on the exterior of the sleeve.

Any axial forces that may arise from the air pressure prevailing at the inlet end of the ejector is considered to have a favourable effect on the wedging action in the tightening direction, whereas forces in the opposite direction are counteracted by the coiled spring. The latter may be dimensioned as desired to generate a force in the order of one to several tens of N, which has to be overcome in order to press the ejector body inwards upon dismounting.

Through the above measures, the ejector according to the invention is arranged for mounting without the need for threads formed on the ejector body exterior, or the need for threads formed internally of the seat. The present invention provides as disclosed an ejector cartridge adapted to be quickly mounted, allowing a far-reaching freedom for integration of the ejector in novel and existing set-ups by simply boring a cylindrical seat and associated flow connections. The invention is disclosed with reference to a diagrammatically illustrated embodiment, from which modifications in the detailed structure of the ejector are possible without departing from the scope of invention.

1. An ejector operative for generating a sub-pressure, the ejector having a rotationally symmetric ejector body (1) arranged to be mounted in the mouth of a seat (8) having a circular internal section, such that in a mounted position an inlet end (2) of the ejector body is inserted in the seat and an outlet end thereof (3) projects outside the mouth of the seat, the ejector characterized by a sleeve (26) which is supported about the ejector body (1) for limited axial displacement thereon, and operative for arresting the ejector in the seat together with the sleeve, said sleeve comprising a cylindrical sleeve wall (27) which is urged by the ejector body to be expanded in radial direction as the sleeve is axially displaced on the ejector body, the sleeve having an outer radius which is dimensioned for clamping the sleeve between the ejector body and the seat in result of its radial expansion.

2. The ejector of claim 1, wherein the ejector body (1) comprises a region (23) of defined axial length and a growing radius towards the inlet end (2), situated between inlet and outlet (23) ends, and a shoulder (24) having an abutment surface facing said region (23), said shoulder being arranged on the ejector body near the outlet end (3), whereby the sleeve is supported for limited axial displacement from the shoulder (24) into said region (23).

3. The ejector of claim 2, wherein said region (23) of growing radius on the ejector body is conically tapering towards the outlet end (3) of the ejector body.

4. The ejector of claim 3, wherein that end of the conical region which faces the inlet end (2) of the ejector body adjoins a groove (34) which is formed to receive a ring-shaped sealing member (37).

5. The ejector of claim 2, wherein a spring member (34) abutting the shoulder (24) is supported on the exterior of the ejector body, said spring member acting between the shoulder (24) and the sleeve (26) supported about the ejector body, the spring member being operative for biasing the sleeve away from the shoulder.

6. The ejector of claim 2, wherein the shoulder (24) is formed on the ejector body, or on an adapter connectable to the ejector body.

7. The ejector of claim 5, wherein the shoulder (24) comprises a ring-shaped groove (35) for receiving a coiled spring recessed into the abutment surface.

8. The ejector of claim 2, wherein a straight cylindrical surface (25) on the ejector body is situated between the shoulder and the region of growing radius, preferably adjoining the shoulder (24), said surface having a radius adapted for guiding the sleeve (26) in axial displacement on the ejector body.

9. The ejector of any claim 2, carrying a sleeve (26) having a cylindrical wall which is divided into sections (27) separated through axial slots (28), said sections being mutually connected in that end of the sleeve which faces the shoulder.

10. The ejector of claim 2, wherein the sleeve comprises a ring-shaped collar (29) formed in that end of the sleeve which faces the shoulder, said collar reaching radially outside the outlet end of the ejector body, and a cylindrical portion (30) reaching in the direction of the outlet end from the periphery of the collar, past the ejector body for some length, to terminate in a grip (31) for fingers.

11. The ejector of claim 9, wherein the wall sections (27) of the sleeve, on the exterior thereof, comprises means (33) for frictional engagement with the seat wall.

12. The ejector of claim 9, wherein the wall sections (27) of the sleeve comprise wedge-shaped heels that reach radially inwardly from an end region of each wall section, respectively, each heel comprising a sloping slide surface (32) the inclination of which is adapted for clamping the sleeve (26) between the ejector body (1) and the wall of the seat (8) in a wedging action upon relative displacement of the sleeve into the region (23) of growing radius on the ejector body.

13. A method for mounting an ejector having a rotationally symmetric ejector body (1) into a seat (8) having a circular internal section, such that in a mounted position an inlet end (2) of the ejector body is inserted in the seat and an outlet end (3) thereof projects outside the mouth of the seat, characterized by insertion of the ejector body (1) into the seat together with a cylindrical sleeve (26) supported about the ejector body, and radially expanding the sleeve for clamping between the seat and the ejector body in result of an axial displacement of the sleeve (26) with respect to the ejector body (1).

14. The method of claim 13, comprising the following steps:
forming a cylindrical seat (8) with a radius adapted for insertion of a rotationally symmetric ejector body (1) together with the sleeve supported on the ejector body;
threading a coiled spring (34) over the ejector body, from an inlet end towards an outlet end thereof, until the coiled spring abuts a shoulder (24) formed at the outlet end;
threading, in said direction, the sleeve over the ejector body until the sleeve engages the coiled spring;
applying one or several ring-shaped sealing means (37) about the ejector body;
displacing the sleeve towards the shoulder against the force of the coiled spring;
insertion of the ejector body and the sleeve under bias such that the sleeve is positioned inside the mouth of the seat;
pulling the ejector body outwards, in effect of the operation of the coiled spring acting between the ejector body and the sleeve, resulting in a radial expansion of the sleeve which is clamped between the ejector body and the wall of the seat.

15. The ejector of claim 3, wherein the shoulder (24) is formed on the ejector body, or on an adapter connectable to the ejector body.

16. The ejector of claim 3, wherein a straight cylindrical surface (25) on the ejector body is situated between the shoulder and the region of growing radius, preferably adjoining the shoulder (24), said surface having a radius adapted for guiding the sleeve (26) in axial displacement on the ejector body.

17. The ejector of any claim 3, carrying a sleeve (26) having a cylindrical wall which is divided into sections (27) separated through axial slots (28), said sections being mutually connected in that end of the sleeve which faces the shoulder.

18. The ejector of claim 3, wherein the sleeve comprises a ring-shaped collar (29) formed in that end of the sleeve which faces the shoulder, said collar reaching radially outside the outlet end of the ejector body, and a cylindrical portion (30) reaching in the direction of the outlet end from the periphery of the collar, past the ejector body for some length, to terminate in a grip (31) for fingers.
